(19) United States
(12) Patent Application Publication
(10) Pub. No.: US 2008/0188201 A1
(43) Pub. Date: Aug. 7, 2008

(54) MOBILE PHONE

(75) Inventor: Hisashi IRII, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/961,675

(22) Filed: Dec. 20, 2007

(30) Foreign Application Priority Data
Feb. 7, 2007 (JP) P2007-027992

(51) Int. Cl. H04M 1/66

(52) U.S. Cl. 455/411

(57) ABSTRACT

According to an aspect of the invention, there is provided a mobile phone including an age acquisition unit configured to acquire an information concerning an age; an age limit acquirement unit configured to acquire an age limit attribute value indicating an age limit is added to a predetermined application program; a judgment unit configured to judge whether the predetermined application program is executable based on the acquired information concerning the age and the acquired age limit attribute value; and an execution unit configured to execute the application program when it is judged by the judgment unit that the application program is executable.

### CROSS-REFERENCE TO RELATED APPLICATIONS

This application is based on and claims the benefit of priority from the prior Japanese Patent Application No. 2007-027992, filed on Feb. 7, 2007; the entire contents of which are incorporated herein by reference.

### TECHNICAL FIELD

The present invention relates to a mobile phone for judging the propriety of execution of an application program such as a game depending on the age of the user.

### BACKGROUND

Recently, with widespread use of mobile phones, chances are growing where a child carries a mobile phone. In order to prevent a child from randomly using the communication feature before the child is allowed to carry a mobile phone, there has been proposed a communication control method whereby the utility time or use count is limited (for example, refer to JP-A-2005-328346).

As mobile phones are getting multi-functional and an execution environment such as Java® is mounted on a mobile phone, the person carrying a mobile phone is allowed to execute an application program such as a game created in a language such as Java®. Even a child carrying a mobile phone may readily execute such as application program in the same way.

Among the application programs such as games used on a mobile phone are ones to be executed restrictively or ones that are urged to be executed because of the age.

In particular, application programs such as games used on a mobile phone include ones harmful to children. There must be some age restriction to keep a child from executing such harmful application programs.

### SUMMARY

According to an aspect of the invention, there is provided a mobile phone including an age acquisition unit configured to acquire an information concerning an age; an age limit acquirement unit configured to acquire an age limit attribute value indicating an age limit is added to a predetermined application program; a judgment unit configured to judge whether the predetermined application program is executable based on the acquired information concerning the age and the acquired age limit attribute value; and an execution unit configured to execute the application program when it is judged by the judgment unit that the application program is executable.

### BRIEF DESCRIPTION OF THE DRAWINGS

In the accompanying drawings:

FIG. 1A, 1B show external views of a mobile phone according to an embodiment;

FIG. 2A, 2 show external views of a mobile phone according to the embodiment;

FIG. 3 is a functional block diagram of the mobile phone according to the embodiment;

FIG. 4A shows the data structure of the user information retained by the mobile phone according to the embodiment;

FIG. 4B shows the data structure of the execution propriety judgment information retained by the mobile phone according to the embodiment;

FIG. 5 shows the data structure of the property information of an application program;

FIG. 6 shows a flowchart showing the procedure in which the mobile phone performs execution propriety Judgment processing;

FIG. 7 shows a flowchart showing the procedure in which the mobile phone performs use information setting processing;

FIG. 8A shows a menu screen for guardians; and

FIG. 8B shows a menu screen for ordinary use.

### DESCRIPTION OF THE EMBODIMENTS

An embodiment of a mobile phone will be described referring to attached drawings.

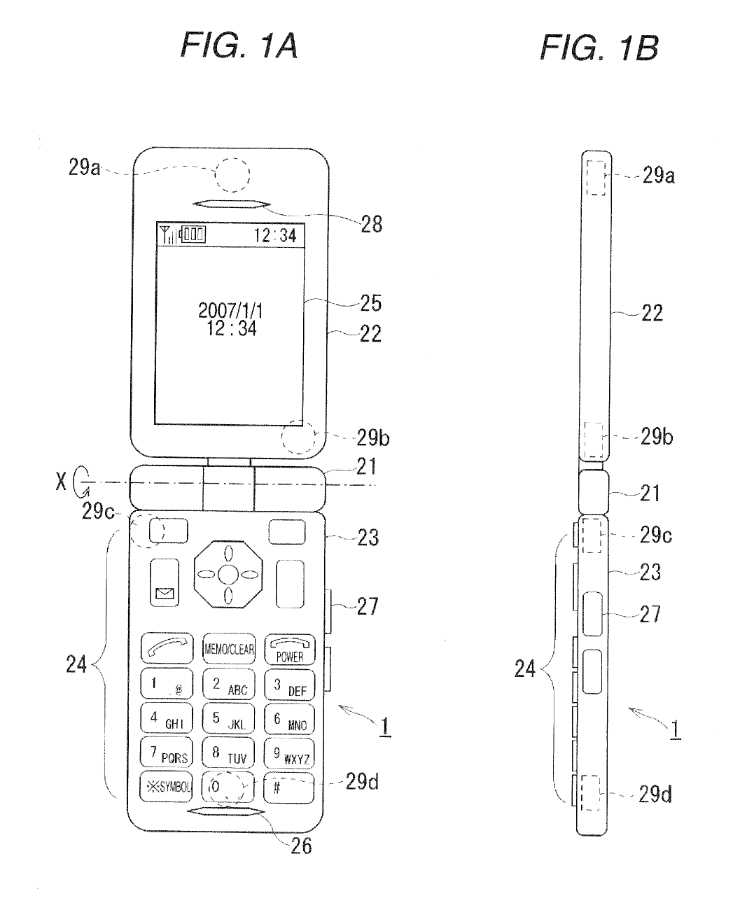

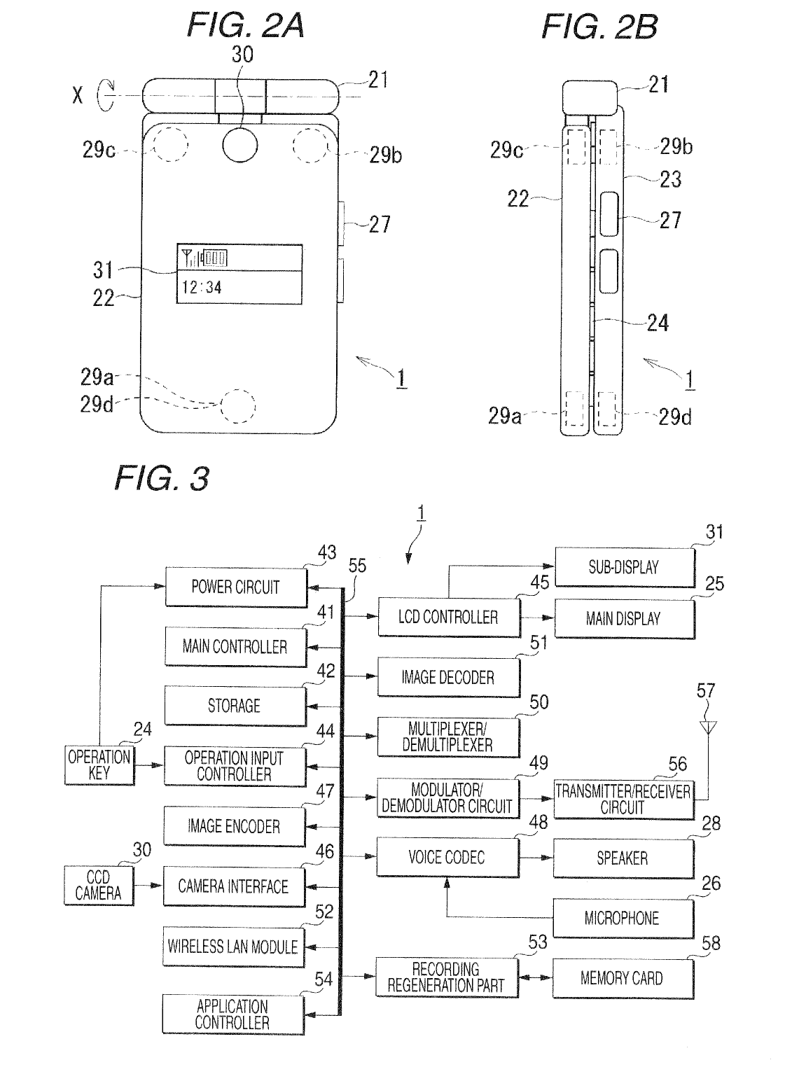

FIGS. 1A, 1B and 2A, 2B show the external configuration of a folding-type mobile phone. FIG. 1A is a front view of a mobile phone 1 unfolded about 180 degrees. FIG. 1B is a side view of the mobile phone 1 in an unfolded state. FIG. 2A is a front view of the mobile phone 1 in a folded state. FIG. 2B is a side view of the mobile phone 1 in the folded state.

As shown in FIGS. 1A, 1B and 2A, 2B, the mobile phone 1 has a first casing 12 and a second casing 13 hinged by way of a central hinge part 21 and is formed in a foldable fashion in the direction of the arrow X shown in FIGS. 1A, 1B and 2A, 2B via the hinge part 21. In a predetermined position inside the mobile phone 1 is provided an antenna for transmission/reception (an antenna 57 in FIG. 3 described later). The mobile phone 1 transmits/receives radio waves to/from a base station (not shown) via the built-in antenna 57.

In a center of the first casing 22 is provided a main display 25. The main display 25 presents an antenna pictograph showing for example the current sensitivity of the antenna 57, a battery pictograph showing the residual battery level of the mobile phone 1 and the current time.

In a predetermined position above the main display 25 is provided a speaker 28 that allows the user to hear the sound stored in the mobile phone 1 or music received by the mobile phone 1.

On the surface of the first casing 22 are arranged operation keys 24 including numeric keys 0 to 9, an off-hook key call button), a redial key, an on-hook/power key, a clear key, and an e-mail key. By using the operation keys 24, the user may input various types of instructions.

On the first casing 12 are arranged, in the upper portion, a crosshair key and an enter key as operation keys 24. The user manipulates the crosshair key horizontally or vertically to move a cursor horizontally or vertically. To be more precise, the user scrolls through a directory list or an e-mail list that appears on the main display 25 provided on the second casing 23 as well as performs page turning and image advancing on a simple home page and other types of operations.

The user may validate various types of features by pressing the enter key. For example, on the first casing 22, a desired directory number is selected from among the plurality of directory numbers in the directory list presented on the main display 25 in accordance with manipulation of the crosshair key by the user. With the enter key pressed in the inner direction of the first casing 22, the selected directory number is validated and a call is initiated to the directory number.

On the first casing 22, an e-mail key is arranged to the left of the crosshair key and enter key. When the e-mail key is pressed in the inner direction of the first casing 22, the e-mail communication feature is activated. To the right of the crosshair key and enter key, a browser key is provided. When the browser key is pressed in the inner direction of the first casing 22, the data on a web page can be browsed. The e-mail key and the browser key to the left and right of the crosshair key and enter key may have various features such as “Yes” and “No” depending on the screen presented on the main display 25, so that the keys are respectively called the soft 1 key and the soft 2 key.

On the first casing 22, a microphone 26 is provided below the operation keys 24. The microphone 26 is used to collect the voice of the user during conversation. On the first casing 22 is provided a side key 27 for operating the mobile phone 1.

Into the first casing 22 is inserted on the back a battery pack (not shown). When the on-hook/power key is turned ON, power is fed to circuits from the battery pack to activate the mobile phone 1 to place it in the operating state.

In predetermined positions inside the first casing 22 and the second casing 23 are arranged magnetic sensors 29a, 29b, 29c, 29d for detecting the unfolded/folded state of the mobile phone 1.

On the first casing 22 and the second casing 23 are respectively provided CCD cameras 30 which allow the user to photograph a desired object.

Below the CCD camera 30 is provided a sub-display 31 that presents an antenna pictograph showing the current antenna sensitivity, a battery pictograph showing the residual battery level of the mobile phone 1 and the current time.

FIG. 3 is a functional block diagram of the mobile phone 1. The mobile phone 1 includes a main controller 41, a storage 42, a power circuit 43, an operation input controller 44, an LCD controller 45, a camera interface 46, an image encoder 47, a voice CODEC 48, a modulator/demodulator circuit 49, a multiplexer/demultiplexer 50, an image decoder 51, a wireless LAN module 52, a recording regeneration part 53, and an application controller 54 interconnected via a bus 55.

The main controller 41 is composed of a CPU (Central Processing Unit) that performs various types of data processing or arithmetic operations. The storage 42 is composed of a magnetic storage such as a ROM (Read Only Memory) for storing a processing program executed by the main controller 41 and a hard disk and an electric storage such as a RAM (Random Access Memory) for temporarily storing data used when the main controller executes processing. The main controller 41 includes a built-in timer for counting the current time.

The power circuit 43 switches between ON and OFF of the power source upon input by the operation key 24 from the user. When the power source is ON, power is fed to each part from the power source (such as the battery back) to place the mobile phone 1 in an operating state.

The operation input controller 44 transmits data inputted with the operation keys 24 to the main controller 41.

The LCD controller 45 presents an image data on the main display 25 or the sub display 3′ based on the control of the main controller 41.

The camera interface 46 presents the signal of an image photographed with the CCD camera 30 on the main display 25 or the sub display 31 via the LCD controller 45.

The image encoder 47 compresses and encodes the image signal supplied from the CCD camera 30 by using a predetermined encoding system such as MPEG-4 (Moving Picture Experts Group-4) to generate image data or converts the encoded image data to new image data in another encoding system. In the process of generating the image data from an image signal inputted from the CCD camera 30, the processing to photograph a still image is still image photography processing and the processing to photograph a moving picture is moving picture image photography processing.

The voice CODEC 48 generates a digital sound signal from the sound collected with a microphone 16. The modulator/demodulator circuit 49 inputs a digital sound signal from the voice CODEC 48 during voice communications and transmits the digital sound signal to a transmitter/receiver circuit 56. The transmitter/receiver circuit 56 transmits the digital sound signal via the antenna 57.

The modulator/demodulator circuit 49 inputs the digital sound signal received by the transmitter/receiver circuit 56 via the antenna 57. The voice CODEC 48 acquires the digital sound signal and converts it to an analog sound signal, and outputs the analog sound signal as a voice from the speaker 28.

The processing in which the voice CODEC 48 stores the signal generated from the sound collected with the microphone 26 into the storage 42 or a second storage 55 is recording processing.

The multiplexer/demultiplexer 50 performs multiplexing to generate a multiplexed signal from multiple signal and demultiplexing to separate a multiplexed signal into multiple signals.

For example, the multiplexer/demultiplexer 50 separates the multiplexed moving picture signal inputted from the modulator/demodulator circuit 49 into an encoded image signal and a sound signal, and transmits the encoded image signal to the image decoder 51 via the main bus 55 as well as transmits the sound signal to the voice CODEC.

The multiplexer/demultiplexer 50 multiplexes the image signal inputted from the image encoder 47 and the sound signal inputted from the voice CODEC by using a predetermined system and transmits the resulting multiplexed signal to the modulator/demodulator circuit 49.

The image decoder 51 inputs an encoded image signal from the transmitter/receiver circuit 56 and decodes the encoded image signal by using a decoding system supporting a predetermined encoding system to generate a playback moving picture signal, and transmits the generated playback moving picture signal to the LCD controller 45. The LCD controller 45 presents the playback moving picture signal on the main display 25 or the sub display 31.

The wireless LAN module 52 performs wireless LAN communications conforming to a predetermined standard such as IEEE802.11a/b/g via a built-in antenna (not shown).

The recording regeneration part 53 includes an interface to an external memory such as a memory card 58 and performs data write/read operation to/from the memory card 58.

The application controller 54 activates an application program prepared in a language such as Java® or terminates a running application program based on an instruction of the user via the operation key 24.

The main controller 41 transmits the text data of an e-mail inputted by manipulation of the operation key 24 to the main controller 41 via the operation input controller 44 when transmitting data such as an e-mail. The main controller 41 executes spread spectrum processing on the text data in the modulator/demodulator circuit 49, performs digital-to-analog conversion and frequency conversion on the resulting data in the transmitter/receiver circuit 56, and transmits the resulting analog signal via the antenna 57.

When receiving an e-mail, the main controller 41 executes inverse spread spectrum processing on a receive signal received via the antenna 57 in the modulator/demodulator circuit 49 and restores the original text data, then presents the text data as a received mail on the main display 25 or the sub display 31. The main controller 41 then records the received mail into the storage 42 in accordance with operation of the user.

The storage 42 stores a plurality of application programs prepared using a language such as Java®. These application programs is executed or terminated by the application controller 54.

Among the application programs are ones to be executed restrictively or ones that are urged to be executed because of the age. In particular, application programs such as games include ones harmful to children. There must be some age restriction to keep a child from executing such harmful application programs.

An application program executed on the mobile phone 1 includes additional age limit information. The application controller 54 includes an execution propriety judgment feature for judging the propriety of execution of an application program based on the age of a person carrying the mobile phone 1 and the age limit of the application program and executing the application program only in case it is executable.

Such application programs and processing programs for executing an application program or executing the execution propriety judgment processing are stored in the storage 42. These processing programs may be received via the transmitter/receiver circuit 46 and installed into the storage 42. Further, the processing programs recorded on the memory card 58 may be installed into the storage 42 via the recording regeneration part 53.

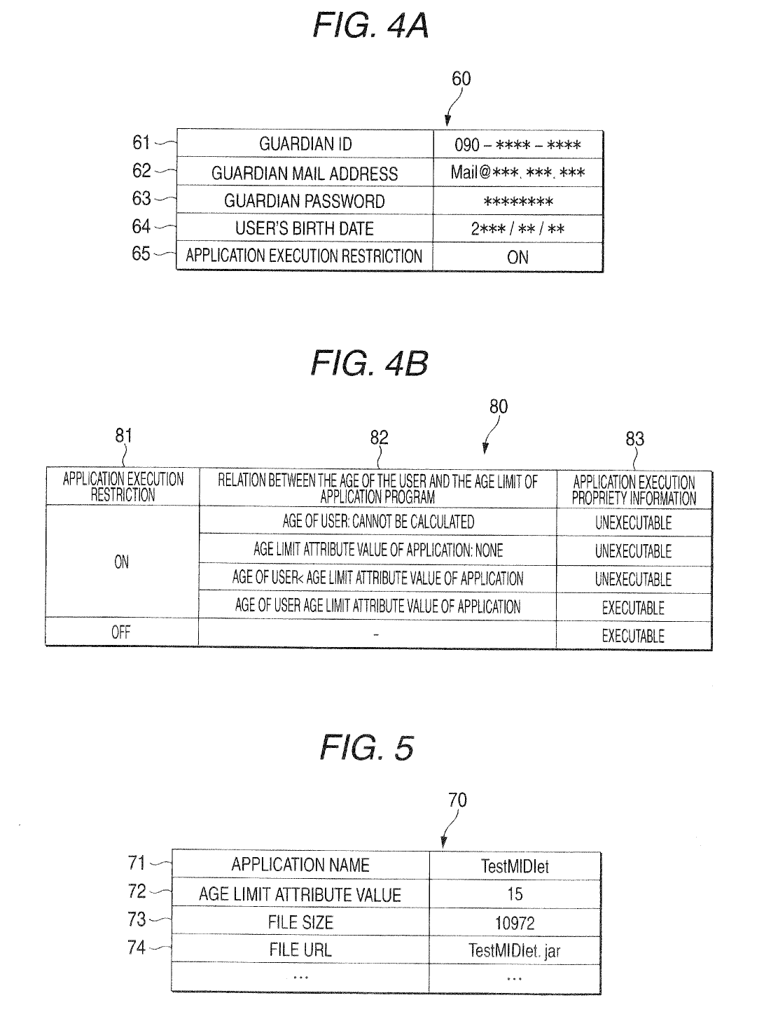

In the storage 42 of the mobile phone 1 is stored user information 60. As shown in FIG. 4A, the user information 60 includes guardian ID information 61 indicating the directory number of a guardian, guardian mail address information 62 indicating the mail address of a guardian, guardian password information 63 indicating the password of a guardian, user's birth date information 64 indicating the birth date of the user, and application execution restriction information 65 indicating whether to apply the execution restriction of an application program. The application execution restriction information 65 is represented as “On” in case execution restriction is applied and “Off” in case execution restriction is not applied.

To an application program such as a game is added proper information 70 indicating the characteristic of the application. The property information 70 is stored in the storage 42. As shown in FIG. 5, the property information 70 includes at least name information 71 indicating an application name, age limit attribute value information 72 indicating the age limit as a boundary age for the propriety of execution of an application program, file size information 73 indicating the file size of an execution file of the application program, and file URL information 74 indicating the location where this execution file is stored.

In the storage 42 of the mobile phone 1 is stored execution propriety judgment information 80 for judging whether an application program is executable. As shown in FIG. 4B, the execution propriety judgment information 80 includes application execution restriction information 81 indicating whether to apply the execution restriction of an application program, relation information 82 indicating the relation between the age of the user and the age limit of an application program, and application execution propriety information 83 associated with each other. The application execution restriction information 81 of the execution propriety judgment information 80 is dependent on the application execution restriction information 65 of the user information 60.

The user information 60, property information and execution propriety judgment information 80 are stored in the storage 42 in a state where correction or deletion is unavailable in an ordinary mode. The user information 60 may be corrected only in case the mobile phone 1 is set to a guardian mode by the guardian.

FIG. 4B shows that, in case the application execution restriction information 65 is “On” and the age of the user cannot be calculated, execution of an application program is “inhibited”, that is, execution of the application program is not permitted. Similarly, in case the application execution restriction information 65 is “On” and the age limit attribute value information 72 of the property information 70 of an application program is not yet specified, execution of the application program is “inhibited”.

In case the application execution restriction information 65 is “On” and the user age information 64 of the user 60 is smaller than the age limit attribute value information 72 of the property information 70, execution of an application program is “inhibited”. In case the application execution restriction information 65 is “On” and the user age information 64 of the user 60 is greater or equal to the age limit attribute value information 72 of the property information 70, execution of an application program is “permitted”.

In case the application execution restriction information 65 is “Off”, execution of an application program is always “permitted” irrespective of the age of the user or age limit of an application program.

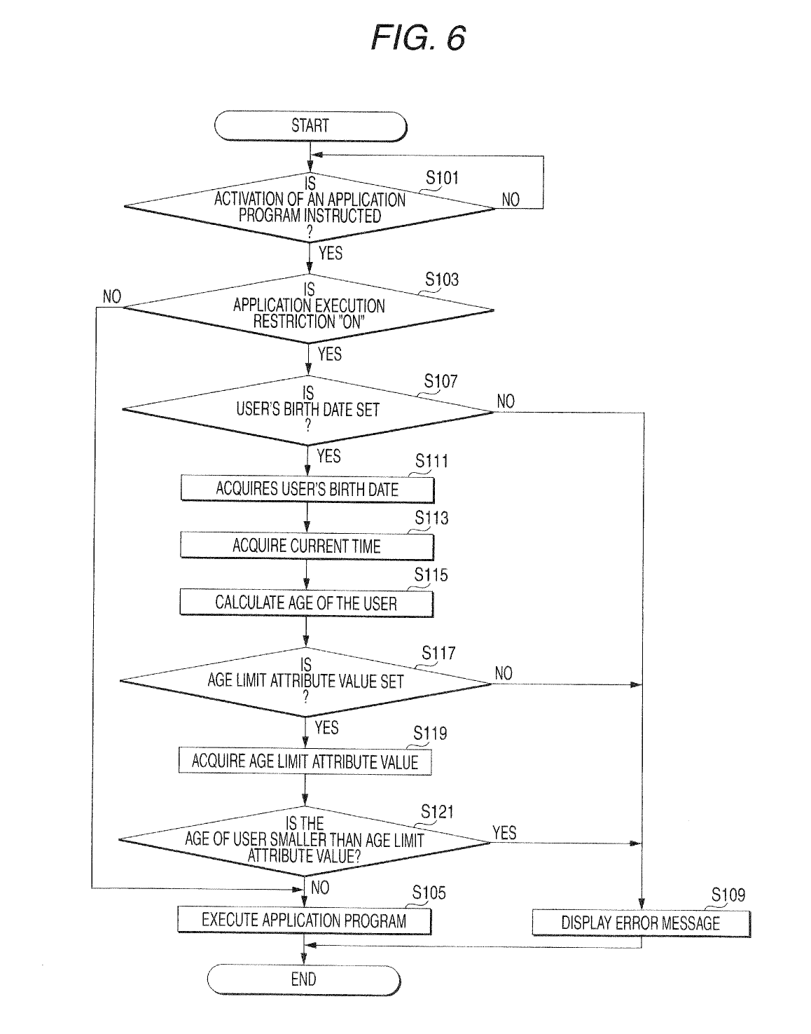

The execution propriety judgment processing made by the mobile phone 1 when an application program such as a game is activated on the mobile phone 1 will be described referring to the flowchart of FIG. 6. The application execution processing is made by judging the execution restriction based on the execution propriety judgment information 80. In the following description, the term “step” is omitted, such as “S101” instead of “step S101”.

The application controller 54 of the mobile phone 1 determines whether activation of an application program is instructed (S101). Activation of the application program is instructed for example by selection of an execution file for the application program by the user. In case activation of an application program is not instructed (No in S101), the application controller 54 is placed in a standby state.

In case activation of an application program is instructed (Yes S101), the application controller 54 acquires the application execution restriction information 65 of the user information and determines whether the application execution restriction information 65 is “On” (S103).

In case the application execution restriction information 65 is not “On” (No in S103), that is, in case the application execution restriction information 65 is not “Off”, the application execution propriety information 83 is always “executable” irrespective of the other information, so that the application controller 54 executes the application program (S105).

In case the application execution restriction information 65 is “On” (Yes in S103), the application controller 54 determines whether the user's birth date information 64 is set to the user information 60 (S107). In case the user's birth date information 64 is not set (No in S107), the age of the user cannot be calculated so that the application execution propriety information 83 is “inhibited”. The application controller 54 presents an error message on the main display 25 (S109) and terminates the execution propriety judgment processing without executing the application program.

In case the user's birth date information 64 is set (Yes in S107), the application controller 54 acquires the user's birth date information 64 from the storage 42 (S111). The application controller 54 also acquires the information on the current time from the main controller 41 (S113). The application controller 54 uses the user's birth date information acquired in S111 and the current time acquired in S113 to calculate the current age of the user (S115).

The application controller 54 determines whether the age limit attribute value information 72 is set to the property information 70 (S117) In case the age limit attribute value information 72 is not set (No in S117), the application execution propriety information is “inhibited”. The application controller 54 presents an error message on the main display 25 (S109) and terminates the execution propriety judgment processing without executing the application program.

In case the age limit attribute value information 72 is set (Yes in S117), the application controller 54 acquires the age limit attribute value information 72 from the storage 42 (S119). The application controller 54 determines whether the current age of the user calculated in S115 is smaller than the age limit attribute value of the age limit attribute value information 72 acquired in S119 (S121).

In case the current age of the user is smaller than the age limit value (Yes in S121), the application execution propriety information 83 is “inhibited”. The application controller 54 presents an error message on the main display 25 (S109) and terminates the execution propriety judgment processing without executing the application program.

In case the current age of the user is not smaller than the age limit value (No in S121), that is, in case the current age of the user is greater than or equal to the age limit value, the application execution propriety information 83 is “permitted”. The application controller 54 executes the application program.

In this way, the mobile phone 1 calculates the age of the person carrying the mobile phone 1 from his/her birth date and the current time. Only in case the age of the person satisfies the age limit of an application program, the xxx executes the application program.

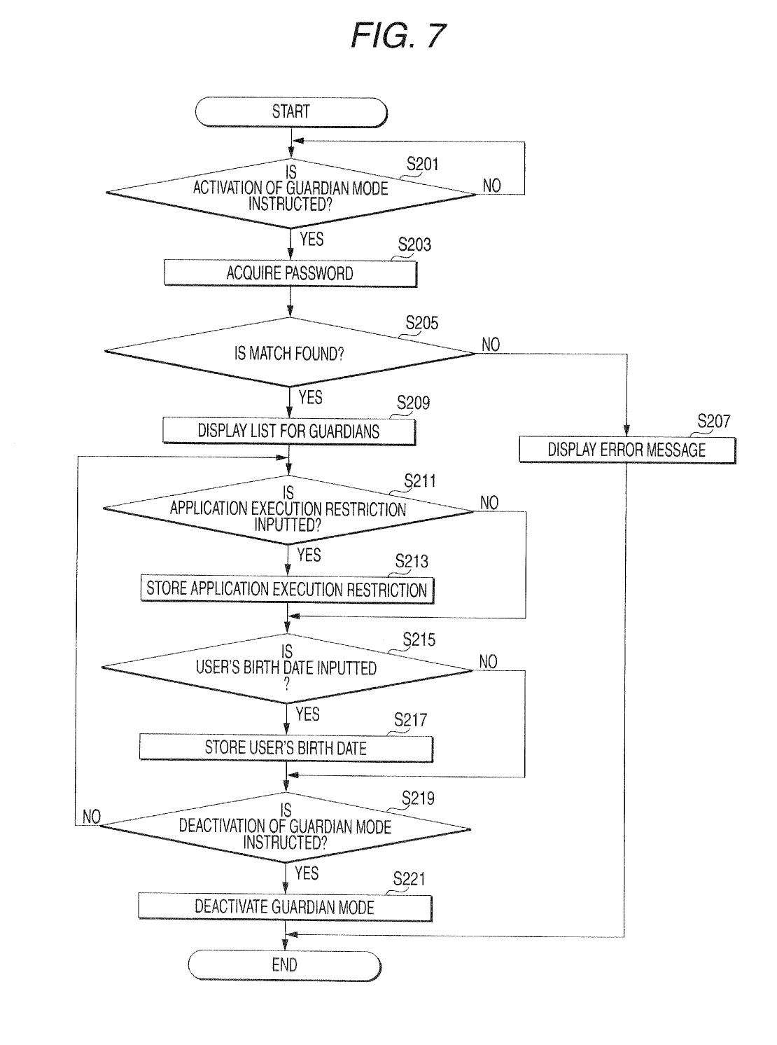

Next, the procedure whereby the mobile phone 1 performs the user information setting processing, that is, corrects or deletes the user information 60 such as the user's birth date information 64, will be described based on the flowchart of FIG. 7. The setting processing is performed by a guardian rather than the person carrying the mobile phone 1 only in case the guardian mode is activated by the guardian.

First, the main controller 41 determines whether activation of the guardian mode is instructed (S201). Instruction to activate the guardian mode is made for example by a push on a predetermined operation key 24 or selection of a trigger to activate the guardian mode from the menu list presented on the main display 25. In case activation of the guardian mode is not instructed (No in S201), the main controller 41 is placed in a standby state.

In case activation of the guardian mode is instructed (Yes in S201), the main controller 41 presents a password input column on the main display 25 to prompt the user to input a password, and acquires the inputted password (S203).

The main controller 41 acquires the guardian password information 63 of the user information 60 from the storage 42 and determines whether the password inputted in S203 matches the guardian password information 63 (S205). In case a match is not found between both passwords (No in S205), the main controller 41 presents an error message on the main display 25 (S109) and aborts the user information setting processing.

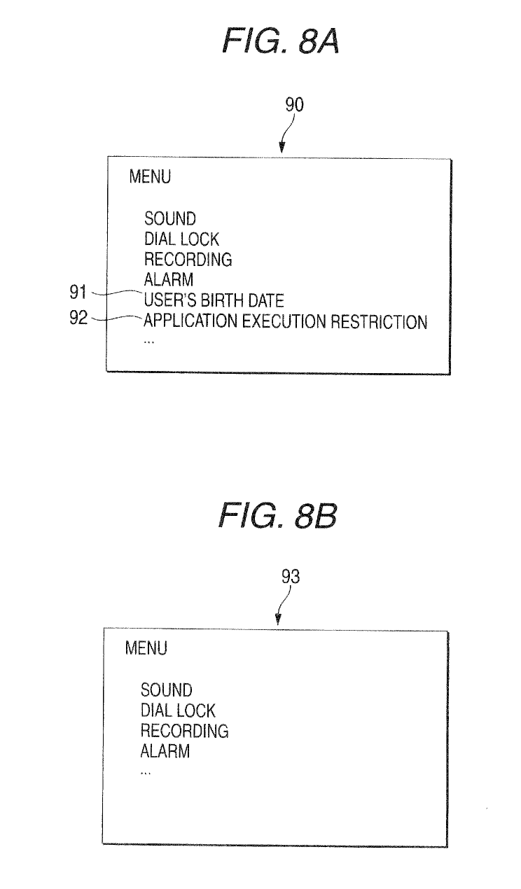

In case a match is found between both passwords (Yes in S205), the main controller 41 activates the guardian mode and presents a list for guardians on the main display 25 (S209). FIG. 8A is a list screen 90 for guardians. FIG. 8B is a list screen 93 for ordinary use (for a person carrying the mobile phone). The list screen 93 for ordinary use displays items such as “Sound”, “Dial lock”, “Recording” and “Alarm”. The list screen 90 for guardians further displays an item 91 “User's birth date” and an item 92 “Application execution restriction”.

When the item 91 “User's birth date” is selected by the user, the main controller 41 presents a user's birth date input column (not shown) on the main display 25 to prompt the user to input the user's birth date. When the item 92 “Application execution restriction” is selected by the user, the main controller 41 presents an application execution restriction input column (not shown) on the main display 25 to prompt the user to input “On” or “Off” as an application execution restriction.

The main controller 41 determines whether the item 92 “Application execution restriction” is selected and the application execution restriction is inputted by the guardian (S211). In case the application execution restriction is inputted Yes in S211), the main controller 41 stores the inputted application execution restriction as application execution restriction information 65 of the user information 60 into the storage 42 (S213)

The main controller 41 determines whether item 91 “User's birth date” is selected and the user's birth date is inputted by the guardian (S215) in case the user's birth date is inputted by the guardian (Yes in S215), the main controller 41 stores the inputted user's birth date as the user's birth date information 64 of the user information 60 into the storage 42 (S217).

The main controller 41 determines whether deactivation of the guardian mode is instructed (S219). The instruction to deactivate the guardian mode is made for example by a push on a predetermined operation key 24 or selection of a trigger to deactivate the guardian mode from the menu list presented on the main display 25. In case deactivation of the guardian mode is not instructed (No in S219), execution returns to S211. In case deactivation of the guardian mode is instructed (Yes in S219), the main controller 41 deactivates the guardian mode activated in S209 (S221).

In this way, on the mobile phone 1, data input, correction or deletion is enabled only while the guardian mode is active concerning the user's birth date information 64 or application execution restriction information 65 of the user information 60. This prevents an erroneous age from being calculated by a change to the birth date of the person carrying the mobile phone on his/her authority. A change to the current time may be made available only while the guardian mode is active.

The processing in step S111 is a birth date acquisition unit. The processing in step S113 is a current time acquisition unit. The processing in step S115 is an age calculation unit. The processing in step S119 is an age limit acquirement unit. The processing in step S121 is determination means. The processing in step S105 is execution unit. Processing in steps S111, S113 and S115 is age acquisition unit.

The storage 42 is a storage unit. The processing in step S209 is a guardian mode activation unit. Processing in steps S211 and S213 is a change unit. The processing in step S221 is guardian mode deactivation unit.

With the mobile phone 1, it is possible to provide a mobile phone that calculates the age of the person carrying the mobile phone 1 based on the birth date of the person and the current time and restricts execution of an application program based on the calculated age before executing an application program having an age limit.

With the mobile phone 1, it is possible to make available a change to the birth date of the person carrying the mobile phone 1 only while the guardian mode is activated by the guardian thus preventing the birth date from being changed on the authority of the person and preventing an erroneous age from being calculated.

The mobile phone 1 may not be a mobile phone but may be a PDA (Persona Digital Assistant), a personal computer, or other types of information processing device.

A series of processing described in the above embodiment may be executed by software as well as by hardware.

While the steps in each flowchart are chronologically executed in the order they are described in the above embodiment, the steps need not always be executed chronologically but may include those executed in parallel or individually executed.

According to the embodiment, it is possible to provide a mobile phone for restricting execution of an application program having an age limit based on the age of a person who attempts to execute the same.

What is claimed is:

1. A mobile phone, comprising:
an age acquisition unit configured to acquire an information concerning an age;
an age limit acquirement unit configured to acquire an age limit attribute value indicating an age limit is added to a predetermined application program;
a judgment unit configured to judge whether the predetermined application program is executable based on the acquired information concerning the age and the acquired age limit attribute value; and
an execution unit configured to execute the application program when it is judged by the judgment unit that the application program is executable.

2. The mobile phone according to claim 1, wherein the judgment unit judges that the predetermined application program is unexecutable if an age of a user is smaller than the age limit attribute value.

3. A mobile phone, comprising:
a birth date acquisition unit configured to acquire an information concerning birth date;
a current time acquisition unit configured to acquire a current time;
an age calculation unit configured to calculate an information concerning an age based on the acquired information concerning the birth date and the acquired current time;
an age limit acquirement unit configured to acquire an age limit attribute value indicating an age limit that is added to a predetermined application program;
a judgment unit configured to judge whether the predetermined application program is executable based on the calculated information concerning the age and the acquired age limit attribute value; and
an execution unit configured to execute the predetermined application program when it is judged by the judgment unit that the predetermined application program is judged executable.

4. The mobile phone according to claim 3, wherein the judgment unit judges that the predetermined application program is unexecutable if an age of a user is smaller than the age limit attribute value.

5. The mobile phone according to claim 3, comprising:
a guardian mode activation unit configured to activate a guardian mode;
a storage unit configured to store the information concerning the birth date;
a guardian mode deactivation unit configured to deactivate the guardian mode; and
a change unit capable of changing the stored birth date information while the guardian mode is active, wherein the birth date acquisition unit acquires the information concerning the birth date from the storage unit.

6. A method for use in a mobile phone, comprising:
acquiring an information concerning birth date;
acquiring a current time;
calculating an information concerning an age based on the acquired information concerning the birth date and the acquired current time;
acquiring an age limit attribute value indicating an age limit that is added to a predetermined application program;
judging whether the predetermined application program is executable based on the calculated information concerning the age and the acquired age limit attribute value; and
executing the predetermined application program when it is judged by the judgment unit that the predetermined application program is judged executable.

7. The method according to claim 6, comprising:
judging that the predetermined application program is unexecutable if an age of a user is smaller than the age limit attribute value.

8. The method according to claim 6, comprising:
activating a guardian mode;
storing the information concerning the birth date;
deactivating the guardian mode;
changing the stored birth date information while the guardian mode is active; and
acquiring the stored information concerning the birth date.
